(19) United States
(12) Patent Application Publication
(10) Pub. No.: US 2019/0168540 A1
(43) Pub. Date: Jun. 6, 2019

(54) Wheel To Axle Securement System

(71) Applicant: Michael Louis Schlags, Buellton, CA (US)

(72) Inventor: Michael Louis Schlags, Buellton, CA (US)

(21) Appl. No.: 15/830,660

(22) Filed: Dec. 4, 2017

(51) Int. Cl. B60B 37/04; B60B 35/00; B60B 27/06

(52) U.S. Cl. CPC B60B 37/04; B60B 2340/50; B60B 27/06; B60B 35/004

(57) ABSTRACT

A wheel to axle securement system (WASS) that facilitates securing a vehicle wheel to an axle, or removal of a vehicle wheel from an axle. The WASS includes a wheel hub with a centered opening, an axle, and a quick release ball lock pin that is dimensioned to be inserted into an axle insert within the axle. The wheel hub is placed onto the axle through the opening such that the axle end is adjacent an outer surface of the hub. The lock pin has at least two balls that extend from or retract into the pin's shaft. A button on the pin actuates an internal assembly. When the button is released, the balls extend outward. Once the hub is on the axle, the pin button is depressed and the pin is inserted into the axle insert. When the button is released the balls are located adjacent and in contact with the end of the axle insert, which functions as a barrier that precludes the pin from being removed from the insert. Once the pin is in place, the hub is secured onto the axle.

### TECHNICAL FIELD

The invention generally pertains to vehicle wheel assemblies, and more particularly to a wheel to axle securement system that allows a wheel to be quickly and easily secured to, or removed from, an axle.

### BACKGROUND ART

One of the earliest developments of humankind was the wheel. The attachment of a disk mite each end of a rod revolutionized movement from one location to another. It became possible to build transportation devices for both people and goods.

As technology improved, designs of the wheel and axle also improved. Essentially all advanced people throughout the world utilized the wheel with the introduction of the internal combustion engine, the wheel/axle assembly became even more important and widely used. Along with the increased usage came the requirement for robust and dependable designs that would allow powered and non-powered vehicles to operate reliably for extended periods of time, over great distances.

Although wheel/axle have been modified as time has progressed, the basic design has remained the same: an axle in the form of a rotatable circular member with a wheel attached to each end. Some of the most significant improvements have been in the materials used to manufacture an axle or wheel, and the methods of securing the wheel onto the axle. For powered vehicles the securement must be extremely strong and reliable since powered vehicles can reach high speeds. Therefore, the securement typically utilizes multiple bolts or similar high strength means. Interesting, these types of designs have been carried over to non-powered vehicles, for which they are usually not required.

A non-powered vehicle, which typically relies on human power to move, can only reach limited speed. As such the securement of the wheel to the axle does not have to be comparable to powered vehicles.

In fact, for non-powered vehicles it is often preferably to utilize a simpler securement design which does not require the time or effort to secure or remove a wheel to or from an axle. A design that could provide a strong securement of a wheel to an axle for a typically non-powered vehicle, and would allow a wheel to be quickly and easily secured to, or removed from, an axle, would be extremely beneficial. If the design could also be applied to powered-vehicles the benefit would be even greater. Optimally, a wheel to axle securement would utilize existing technology that is adapted for this use and therefore would be very effective and could be easily implemented.

A search of the prior art did not disclose any literature or patents that read directly on the claims of the instant invention. However, the following U.S. patents are considered related:

| PAT. NO. | INVENTOR | ISSUED |
|---|---|---|
| 3,749,196 | Traylor | Jul. 31, 1973 |
| 6,575,539 | Reich | Jun. 10, 2003 |
| 6,598,941 | Field, et al | Jul. 29, 2003 |

The U.S. Pat. No. 3,749,196 patent discloses an axle housing mounting structure having one member adapted to be attached to a vehicle frame and another member adapted to be securely attached to the exterior surface of an axle housing. The two members are provided with complementary slidably interfitting surfaces so that the axle housing engaging member may be rotated about a generally horizontal axis with respect to the first member to adjust the angular orientation of the input shaft of a gear box located on the axle housing.

The U.S. Pat. No. 6,575,539 patent discloses an apparatus and method for attaching a wheel to an axle. The apparatus comprises a wheel with a hub far insertion into an indentation in the end of the axle and a non-cylindrically—symmetrical stud attached to the axle that is concentric with the axis of rotation of the wheel and axle, attaching the wheel to the axle.

The U.S. Pat. No. 6,598,941 patent discloses an apparatus and method for attaching a wheel to an axle. The apparatus comprises a wheel with a hub for insertion into an indentation in the end of the axle and a single bolt that is offset from the axis of rotation of the wheel and axle and that attaches the wheel to the axle.

For background purposes and indicative of the art to which the invention relates, reference may be made to the following remaining patents found in the patent search.

| PAT. NO. | INVENTOR | ISSUED |
|---|---|---|
| 3,773,347 | Traylor | Nov. 20, 1973 |
| 5,800,023 | Hartenstine, et al | Sept. 1, 1998 |
| 6,203,472 | McCaffrey, et al | Mar. 20, 2001 |
| 8,820,853 | Barefoot | Sept. 2, 2014 |

### DISCLOSURE OF THE INVENTION

A wheel to axle securement system (WASS) that facilitates securing a vehicle wheel to an axle, or removal of a vehicle wheel from an axle. The WASS includes a vehicle wheel with a wheel hub, an axle with a first end and a second end, with a wheel hub secured to each end, and a quick release ball lock pin that is dimensioned to fit with an axle insert that is located inside the axle at each end. The wheel hub is placed onto the axle by inserting the axle through an opening at the center of the hub. The opening is designed so that the axle is stopped from extending past an outer surface of the hub. Once the wheel hub is on the axle, the ball lock pin is inserted into the axle insert within the axle. The ball lock pin, which is also known as a pit pin, and as well known in the art, utilizes a pair of opposed metal balls that extend outward from the pin. An internal mechanism causes the balls to retract downward into the shaft when a button on the pin is depressed with the balls retracted, the shaft has a flush surface, which can be inserted into the axle insert. Once the pin is inserted, the pin's button is released which causes the balls to extend upward and outward. The location of the pin when the balls extend, allows the balls to create a barrier that precludes the pin from being removed/extracted from the axle insert. With the pin in place the wheel hub is secured onto the axle.

To remove the wheel hub from the axle, the button on the pin is depressed which causes the balls to retract into the shaft, and the pin to be extracted from the axle insert. With the pin extracted, the wheel hub can easily be removed from the axle.

In view of the above disclosure, the primary object of the invention is to provide a wheel to axle securement system that utilizes current technology to facilitate the quickly and easy securement of a wheel to an axle, or removal of a wheel from an axle.

In addition to the primary object, it is also an object of the invention to provide a wheel to axle securement system that:
can work with many types of vehicles, but is especially suited for use with a rescue litter,
is easy to manufacture and utilizes existing technology,
is easy to use,
allows certain vehicles to be stored or transported with the wheels removed,
is durable and long-lasting,
can be sold as an OEM product or an aftermarket product,
requires no maintenance,
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a front orthographic view of a wheel to axle securement system (WASS) unassembled showing a wheel hub, axle, axle insert and quick release ball lock pin.

FIG. 2 is a front orthographic view of the WASS axle, axle insert and quick release ball lock pin.

FIG. 3 is a cut-away view showing an axle end with the axle insert and quick release ball lock pin.

FIG. 4 is a front orthographic view of the WASS axle and axle insert, with the axle insert having multiple circumferential slots extending laterally around an outer surface of the axle insert.

### BEST MODE FOR CARRYING OUT THE INVENTION

The best mode for carrying out the invention is presented in terms that disclose a preferred embodiment of a wheel to axle securement system (WASS) 10. Ever since the combination of a round disk placed on each end of a rod, humankind has relied on the use of the wheel (or more accurately, the wheel and axle) for many varied purposes. The wheel/axle has also led to the development of some of the most ubiquitous and widely used innovations of the modern world, such as the many different types of vehicles that utilize wheels/axles to function.

The basic design of the wheel/axle has not changed since its initial development. The improvements to the wheel/axle have mostly been the use of better, more advanced materials in the manufacture, as well as improved designs of the construction. This is especially notable in the, methods used to secure a wheel onto an axle. With the introduction of powered vehicles it became necessary to produce a wheel/axle that could operate at and withstand the higher speeds and greater loads that resulted from powered vehicles.

While wheel/axle use for powered vehicles is predominant, there is still a pronounced need for a wheel/axle that is primarily used for non-powered vehicles. In particularly there is a need for an advanced method for securing a wheel to an axle. The WASS 10 addresses this need by providing wheel to axle securement that is quick and easy. To use for both securing a wheel onto an axle, or for removing a wheel from an axle. The WASS 10 is primarily designed for use with a proprietary rescue litter, known as the COBRA LITTER™, which was developed by the same inventor.

Although the WASS 10 is particularly effective for use on the rescue litter, which is usually non-powered, the design of the WASS 10, which is partially derived from modified/improved existing technology, can also be effectively used in many other applications, both powered or non-powered.

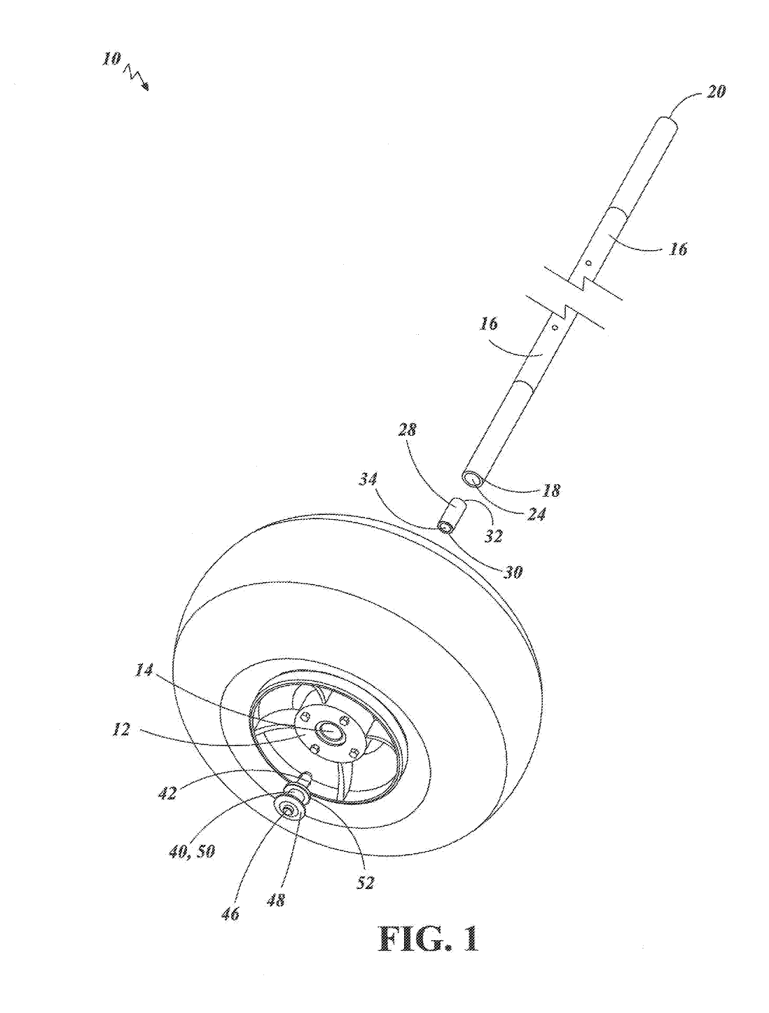

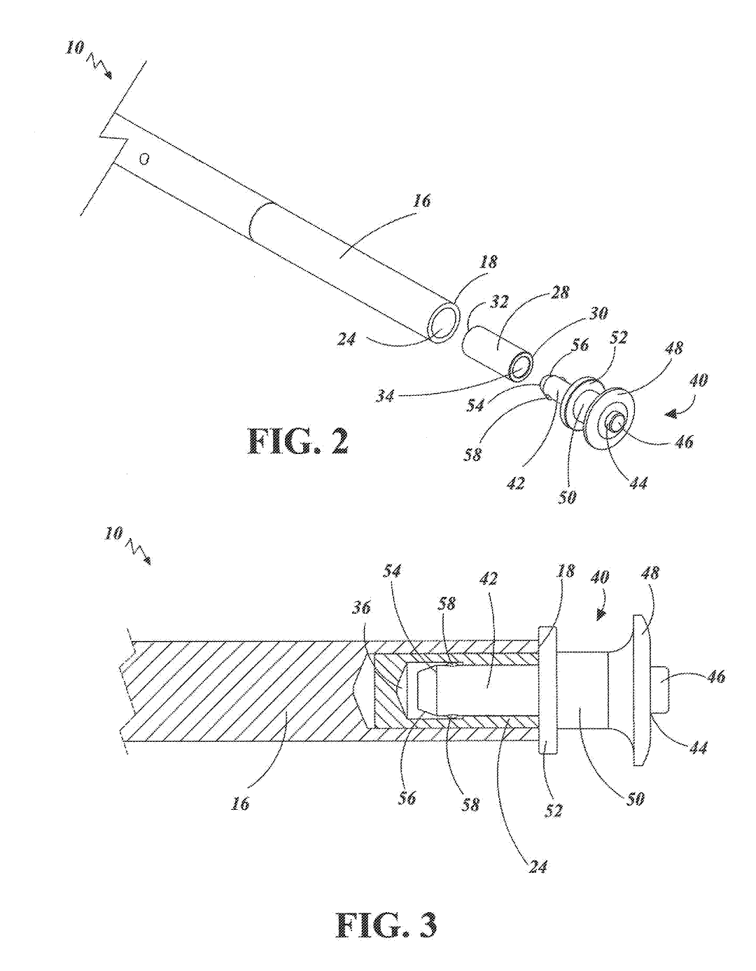

The preferred embodiment of the WASS 10, as shown in FIGS. 1-4, facilitates securing a vehicle wheel to an axle, or removal of a vehicle wheel from an axle. The WASS 10 comprises a vehicle wheel with a wheel hub 12 having a center opening 14, an axle 16 with a first end 18 having an opening 24 and a second end 20 having an opening 24, and a quick release ball lock pin 40. Located within the opening 24 on the axle first end and the axle second end is an axle insert 28 having an outer end 30, an inner end 32 and a bore 34 extending therethrough. The axle insert 28, as shown in FIGS. 1-3 is dimensioned to be inserted into and frictionally maintained within the opening 24 on each axle end. The bore 34 on the axle insert is dimensioned to accept the quick release ball lock pin 40, as shown in FIGS. 1-3, and which comprises a shaft 42 with an outer end 44 from where outwardly extends a button 46, a finger interface collar 48 with an integral shaft member 50 into which substantially half of said axle shaft 42 is inserted, a hub interface collar 52 that is located below said danger interface collar, an inner end 54 that tapers 56 inward, at least two balls 58 that extend outward from corresponding openings in the shaft, and an internal assembly (not shown) comprising a rod that is connected to a spring such that the rod slides forward when the button 46 is depressed, and returns to an original position when the button is released. The at least two balls 58 are located within a V-shaped slot on the shaft. When the button 46 is depressed and the shaft slides forward, and the balls enter into the slot, thereby creating a flush surface along the shaft, which allows the shaft to be inserted or removed from said axle insert, wherein said axle is inserted into the opening on the wheel hub, and the quick release ball lock pin button is depressed and the pin is inserted from the outer surface into the axle insert 28. The ball lock pin hub interface collar 52 contacts the axle's first end, thereby precluding further insertion at the pin 40. To remove the wheel hub 12 from the axle 16, the button 46 on the ball lock pin 40 is depressed, thereby causing the balls 58 to retract into the shaft, which allows the pin 40 not be extracted from the axle insert 28, and the wheel hub 12 to be removed from the axle 16.

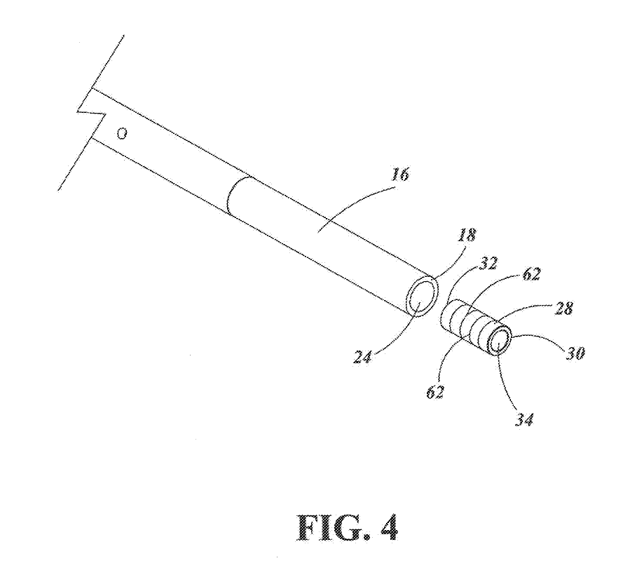

As shown in FIG. 4, the axle insert 28 can additionally include at least one, and preferably multiple, circumferential slots 62. The slots 62 extend laterally around an outer surface of the axle insert 28. When the axle insert 28 is inserted into the axle opening 24, each circumferential slot 62 expands, which enlarges the diameter of the axle insert 28, thereby providing increased frictional maintaining of the axle inset 28 within the axle opening 24.

While the invention has been described in detail and pictorially shown in the accompanying drawings it is not to be limited to such details, since many changes and modification may be made to the invention without departing from the spirit and the scope thereof. Hence, it is described to cover any and ail modifications and forms which may come within the language and scope of the claims.

1. A wheel to axle securement system (WASS) that facilitates securing a vehicle wheel to an axle, or removal of a vehicle wheel from an axle, wherein said WASS comprises a wheel hub having a centered opening; an axle with a first end and a second end, with each end secured to a wheel hub; and a quick release ball lock pin that is dimensioned to be inserted into an axle insert located within, and at an end, of said axle, wherein said wheel hub is placed onto said axle by inserting an axle end into the opening on said hub, wherein said ball lock pin is inserted from an outer surface into said axle insert within said axle, wherein said ball lock pin includes at least two balls that extend outward from said pin when said pin is actuated and inserted into said axle insert, wherein said axle insert functions as a barrier that the balls contact, which precludes said pin from being removed once inserted, wherein said pin inserted secures said wheel hub to said axle, wherein to remove said wheel hub from said axle, said pin is actuated which causes the balls to retract and allows said pin to be extracted from said axle insert, thereby also allowing said wheel hub to be removed from said axle.

2. The wheel to axle securement system as specified in claim 1 wherein said vehicle wheel comprises said wheel hub.

3. The wheel to axle securement system as specified in claim 2 wherein said wheel hub is made of plastic or metal.

4. The wheel to axle securement system as specified in claim 1 wherein said axle is made of plastic or metal.

5. The wheel to axle securement system as specified in claim 1 wherein said quick release ball lock pin is circular and made of metal.

6. A wheel to axle securement system (WASS) that facilitates securing a vehicle wheel to an axle, or removal of a vehicle wheel from an axle, wherein said WASS comprises a vehicle wheel with a wheel hub having an center opening, an axle with a first end having an opening and a second end having an opening and a quick release ball lock pin, wherein located within the opening on said axle first end and aide said second end is an axle insert having an outer end, an inner end and a bore extending therethrough, wherein said axle insert is dimensioned to be inserted into and frictionally maintained within the opening on each said axle end, wherein the bore on said axle insert is dimensioned to accept said quick release ball lock pin which comprises a shaft with an outer end from where outwardly extends a button, a finger interface collar with an integral shaft member into which substantially half of said axle shaft is inserted, a hub interface collar that is located below said finger interface collar, an inner end that tapers inward, at least one ball that extends outward from a corresponding opening in the shaft and an internal assembly comprising a rod that is connected to a spring such that the rod slides forward when the button is depressed, and returns to an original position when the button is released, wherein the at least one ball is located within a V-shaped slot on the shaft, wherein when the button is depressed and the shaft slides forward and the ball enters into the slot, thereby creating a flush surface along the shaft, which allows the shaft to be inserted or removed from said axle insert, wherein said axle is inserted into the opening on said wheel hub, and said quick release ball lock pin button is depressed and said pin is inserted from the outer surface into said axle insert, wherein said ball lock pin hub interface collar contacts said axle's first end, thereby precluding further insertion of said pin, wherein once said pin is fully inserted, the button is released, thereby causing the at least one ball to extend upward, out of the opening on the shaft, wherein the extended ball is located directly adjacent to and in contact with the inner end of said axle insert, thereby creating a barrier of said axle insert to removing said pin, which secures said wheel hub to said axle wherein to remove said wheel hub from said axle, the button on said ball lock pin is depressed thereby causing the ball to retract into the shaft, which allows said pin not be extracted from said axle insert, and said wheel hub to be removed from said axle.

7. The wheel to axle securement system as specified in claim 6 wherein said wheel hub is made of plastic or metal.

8. The wheel to axle securement system as specified in claim 6 wherein said axle is made of plastic or metal.

9. The wheel to axle securement system as specified in claim 6 wherein said quick release ball lock pin is circular and made of metal.

10. The wheel to axle securement system as specified in claim 6 wherein said axle insert further comprising at least one circumferential slot that extends laterally around an outer surface of axle insert, wherein when said axle insert is placed within the axle opening, said circumferential slot expands which enlarges the diameter of said axle insert, thereby providing increased frictional maintaining of said axle insert within the axle opening.

11. A wheel to axle securement system (WASS) that facilitates securing a vehicle wheel to an axle, or removal of a vehicle wheel from an axle, wherein said WASS comprises a vehicle wheel with a wheel hub having an center opening, an axle with a first end having an opening and a second end having an opening, and a quick release ball lock pin, wherein located within the opening on said axle first end and axle said second end is an axle insert having an outer end, an inner end and a bore extending therethrough, wherein said axle insert is dimensioned to be inserted into and frictionally maintained within the opening on each said axle end, wherein the bore on said axle insert is dimensioned to accept said quick release ball lock pin which comprises a shaft with an outer end from where outwardly extends a button, a finger interface collar with an integral shaft member into which substantially half of said axle shaft is inserted, a hub interface collar that is located below said finger interface collar, an inner end that tapers inward, at least two balls that extend outward from corresponding openings in the shaft and an internal assembly comprising a rod that is connected to a spring such that the rod slides forward when the button is depressed, and returns to an original position when the button is released, wherein the at least two balls are located within a V-shaped slot on the shaft, wherein when the button is depressed and the shaft slides forward and the balls enter into the slot, thereby creating a flush surface along the shaft, which allows the shaft to be inserted or removed from said axle insert, wherein said axle is inserted into the opening on said wheel hub, and said quick release ball lock pin button is depressed and said pin is inserted from the outer surface into said axle insert, wherein said ball lock pin hub interface collar contacts said axle's first end, thereby precluding further insertion of said pin, wherein once said pin is fully inserted, the button is released, thereby causing the at least two balls to extend upward, out of the opening on the shaft, wherein the extended balls are located directly adjacent to and in contact with the inner end of said axle insert, thereby creating a barrier of said axle insert to removing said pin, which secures said wheel hub to said axle wherein to remove said wheel hub from said axle, the button on said ball lock pin is depressed thereby causing the balls to retract into the shaft, which allows said pin not be extracted from said axle insert, and said wheel hub to be removed from said axle.

15. The wheel to axle securement system as specified in claim 11 wherein said wheel hub is made of plastic or metal.

16. The wheel to axle securement system as specified in claim 11 wherein said axle is made of plastic or metal.

17. The wheel to axle securement system as specified in claim 11 wherein said axle insert further comprising a plurality of circumferential slots that extend laterally around an outer surface of said axle insert, wherein when said axle insert is inserted into the axle opening, each said circumferential slot expands which enlarges the diameter of said axle insert, thereby providing increased frictional maintaining of said axle insert within the axle opening.
